(19) United States
(12) Patent Application Publication
(10) Pub. No.: US 2006/0282337 A1
(43) Pub. Date: Dec. 14, 2006

(54) METHOD OF PRODUCT INFORMATION DISTRIBUTION

(76) Inventor: Kevin P. Combs, McKinney, TX (US)

Correspondence Address: Michael A. O'Neil;Michael A. O'Neil, P.C., Suite 820, 5949 Sherry Lane, Dallas, TX, 75225, US

(21) Appl. No.: 11/461,484

(22) Filed: Aug. 1, 2006

Related U.S. Application Data
(63) Continuation-in-part of application No. 11/423,468, filed on Jun. 12, 2006.
(60) Provisional application No. 60/689,843, filed on Jun. 13, 2005.

(51) Int. Cl. G06Q 30/00

(52) U.S. Cl. 705/26

(57) ABSTRACT

A method for providing product information enabling consumers a time efficient means for acquiring information about and/or purchase products identified in product promotions. The method also facilitates tracking of the number of customer contacts with and purchases from each product advertisement.

### CROSS-REFERENCE TO RELATED APPLICATIONS

This application is a continuation-in-part application of application Ser. No. 11/423,468 filed Jun. 12, 2006, currently pending, the entire contents of which are incorporated herein by reference; which claims priority based on provisional patent application Ser. No. 60/689,843 filed Jun. 13, 2005, the entire content of which is incorporated herein by reference.

### TECHNICAL FIELD

This invention relates generally to methods for providing product information, and more particularly to a method of providing product information that allows consumers to acquire information about and/or purchase advertised products quickly and with minimum difficulty. The invention also allows advertisers to track responses to specific ad placements.

### BACKGROUND AND SUMMARY OF THE INVENTION

Internet advertising and sales have grown exponentially in recent years and are quickly approaching the $200 billion mark. Online sales account for a substantial portion of sales made by conventional retailers, and some retailers such as AMAZON.COM® sell exclusively online. Most print and audio-visual advertisements identify a website associated with the advertised retail merchant or product. Consumers are often drawn to retail websites based on products seen in advertisements. However, consumers are often unable to find the specific product of interest in a time efficient manner which can result in a lost sale.

For example, a female consumer may see a blouse in a department store ad and attempt to find and purchase the blouse online. To do so the consumer must first find the retailer's web site, then search a general category such as women's clothing for another subcategory such as blouses. In some cases there may be additional subcategories such as sleeveless, long sleeve, etc. Once the consumer locates the appropriate subcategory, if at all, she must then search through numerous products within the subcategory in an attempt to find the desired product. The aforementioned process can take several minutes during which the consumer may become frustrated and lose interest in purchasing the blouse. What is needed is a method for providing product and purchase information in a brief period of time such that a consumer can quickly access information pertaining to the desired product and immediately purchase the desired product.

The present invention comprises a method of product information distribution which overcomes the foregoing and other difficulties which have long since characterized the prior art. In accordance with the broader aspects of the invention, a method of providing product information provides an interaction process for quickly and easily locating advertised products on the internet.

In accordance with more specific aspects of the invention, a method of providing product information comprises providing a unique product information number for each item advertised. The product information number is a unique identifier specific to a particular product and merchant. When a consumer identifies a product in an advertisement or at a shopping venue that he is interested in purchasing, the consumer enters the product number from the advertisement into the prompt of a conventional internet search engine, a specialized search engine such as FASTBUY.COM®, or a merchant's website such as the search box within AMAZON.COM®. The selected search engine then links the consumer directly to a website specific to the identified product and merchant.

The product identification number enables a consumer to directly access information relating to and/or purchase the identified product without having to navigate through a series of screens and menu choices. Adjacent to the product information the merchant may also provide related and other products that the consumer may be interested in purchasing and/or suggest related and other products and product categories that may interest the consumer.

In accordance with another aspect of the invention, each product identification number is specific not only to an individual product but also to specific placements of ads for the products. This allows advertisers to track the number of responses to each ad placement thereby facilitating better management of the advertising budget.

### DETAILED DESCRIPTION

### Introduction

The following example describes a method of providing product information and facilitating product purchase. The present invention is equally applicable to merchants of all types including conventional retailers, e-commerce retailers, and direct sellers, and to all types of merchandising.

### EXAMPLE

A retailer or manufacturer (hereinafter “merchant”) identifies a product to offer for sale. Each product number offered for sale is assigned a unique product identification number. If desired the product identification number may have embedded therein one or more symbols unique to a specific merchant. A unique internet address is created for each product identification number. Once the internet address is created detailed product and price information is displayed on the website. Further provided on the website is a link to an internet shopping cart enabling instant purchase of the product therefrom. Product and price information can also be stored in the FAST-QUE feature of the FASTBUY.COM website for later purchase.

The merchant selects means for advertising the identified product. The advertising means may comprise advertisements in magazines, newspapers, catalogs, or other suitable media for product advertisement. Each advertisement of the identified product includes the unique alpha-numeric product identification number for the product identified therein. If more than one product is advertised, an alpha-numeric product number for each advertised product is included therein.

A consumer viewing an advertisement and interested in a product displayed therein or seeing a desired product at a retail venue may then utilize the product identification number to find the product for sale on an internet web site. The consumer accesses a specialized search engine such as FASTBUY.COM®, or a merchant's website, for example, such as the search box within AMAZON.COM®, and enters the product identification number into the search prompt provided thereon. The search engine locates the unique internet address assigned to the product identification number and links the consumer directly thereto. When the website is displayed the consumer has access to the detailed product and price information for the identified product and decides whether to purchase the identified product, not to purchase the identified product, or to store the product and price information for subsequent purchase, for example by accessing the FAST-QUE feature of the FASTBUY.COM website or the like. Adjacent to the specific product information the merchant may also display related and other items that may interest the consumer. The merchant may also provide links to its home page enabling the consumer to locate other items of interest for purchase.

The method of the present invention may also be used to facilitate re-ordering an identified product without having to the recall a specific product name or number by incorporating the product identification number into the labeling of the product. As indicated above the customer can also store product and price information relating to preferred products for subsequent utilization.

In accordance with another aspect of the invention, individual product identification numbers and websites are unique not only to a specific product but also to a specific ad placement for the product. For example, assume that product X is advertised in a specific issue of magazine A, a specific issue of magazine B, and a specific issue of magazine C. Even though the same product is advertised in all three magazines, a different product number and website is assigned for each of the three advertising placements for the product.

Information comprising the number of visits to and the number of purchases from each website is routed to a common data collection point maintained by the advertiser that placed the ads, for example, information from the websites comprising specific ad placements can be directed to a central website. By tracking the number of visits to and the number of purchases from each website the advertiser can determine which of the three magazines is generating the most exposure to and purchases of the product. This in turn allows the advertiser to better manage the advertising budget for the product by focusing on advertisements the generate the most sales of the product.

Although preferred embodiments of the invention have been illustrated in the foregoing Detailed Description, it will be understood that the invention is not limited to the embodiments disclosed, but is capable of numerous rearrangements, modifications, and substitutions of parts and elements without departing from the spirit of the invention.

1. For use in conjunction with the marketing of products, a method of providing product information to a consumer comprising the steps of:
identifying as product to offer for sale;
assigning a unique product identification number to the identified product;
selecting product promotion means for the identified product;
including the assigned product identification number in the selected product promotion means;
creating a unique internet address for each product identification number;
providing detailed product and price information at the unique internet address;
providing the unique internet address and its corresponding product identification number to at least one internet search engine for linking therefrom;
linking a consumer who has entered the product identification number into the search engine to the unique internet address;
providing means for the consumer to purchase the identified product;
providing means for the customer to store product and price information relating to the identified product.

2. For use in conjunction with the marketing of products, a method of tracking consumer response to advertisements comprising the steps of:
identifying as product to offer for sale;
selecting multiple advertisements for advertising the identified product;
assigning a unique alpha-numeric product identification number to each of the selected advertisements for the identified product;
including the assigned product identification number in each selected advertisement;
creating a unique internet address for each selected advertisement;
providing detailed product specific information at each unique internet addresses;
providing all of the unique internet addresses and the corresponding product identification number to at least one internet search engine for linking therefrom;
linking a consumer who has entered any of the product identification numbers into the search engine to the corresponding unique internet address;
providing means for the consumer to purchase the identified product;
providing means for the consumer to store product and price information relating to the identified product;
reporting the number of customer contacts and purchase from with each of the unique internet address.
